(19) United States
(12) Patent Application Publication
(10) Pub. No.: US 2016/0041751 A1
(43) Pub. Date: Feb. 11, 2016

(54) METHOD OF STACKING INTERFACES AND MANAGING RESPONSES AND ELECTRONIC DEVICE USING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YA-LING LIU, Shenzhen (CN); CHIH-SAN CHIANG, New Taipei (TW); HAI-SEN LIANG, Shenzhen (CN); HAI-JUN MAO, Shenzhen (CN); TAO LIU, Shenzhen (CN)

(21) Appl. No.: 14/541,901

(22) Filed: Nov. 14, 2014

(30) Foreign Application Priority Data
Aug. 8, 2014 (CN) 201410388539.9

(51) Int. Cl. G06F 3/0488

(52) U.S. Cl. CPC G06F 3/04886

(57) ABSTRACT

An electronic device with a display of stacked interfaces includes a touch panel, a display unit, a determination unit, and a processing unit. The touch panel has a detection unit for detecting a present touch on the touch panel and generating a signal of touch. The display unit can display two stacked interfaces, an upper interface and a lower interface. The determination unit is configured to determine whether a present touch is applied to the upper interface or to the lower interface. When the present touch is on the upper interface, the determination unit transmits the signal of touch from the upper interface to the lower interface. The processing unit is configured to control the upper interface or the lower interface to respond accordingly to the signal of touch.

### FIELD

The subject matter herein generally relates to interfaces with electronic devices.

### BACKGROUND

Multilayer overlay technology is widely used in a variety of electronic devices, such as smart TVs and smart phones. With such technology, at least two interfaces are stackable and displayed on a screen and the upper interface can be operated by users.

### BRIEF DESCRIPTION OF THE DRAWINGS

Implementations of the present technology will now be described, by way of example only, with reference to the attached figures.

FIG. 1 is a block diagram of an electronic device in an embodiment.

FIG. 2 is a flowchart of a method of stacking interfaces and managing responses using the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

The present disclosure is described in relation to an electronic device. The electronic device includes a touch panel, a display unit, a determination unit, and a processing unit. The touch panel has a detection unit for detecting a touch on the touch panel and generating a signal of touch. The display unit is configured to display two stacked interfaces, an upper interface and a lower interface. The determination unit is configured to determine whether the present touch is on the upper interface or the lower interface. When the present touch is on the upper interface, the determination unit transmits the signal of touch from the upper interface to the lower interface. The processing unit is configured to control the upper interface or the lower interface to respond the operation signal.

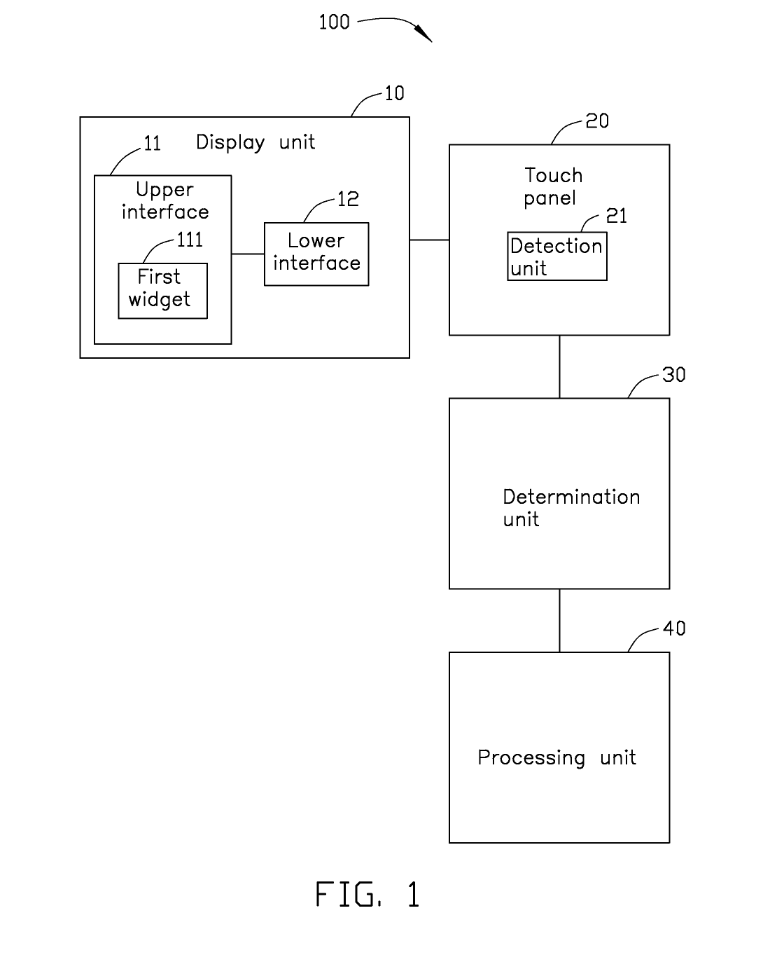

FIG. 1 illustrates that an electronic device 100 includes a touch panel 20, a display unit 10, a determination unit 30, and a processing unit 40. In at least one embodiment, the electronic device 100 can be a smart TV or a smart phone.

A display unit 10 is configured to display at least an upper interface 11 and a lower interface 12 which are stackable via a multilayer overlay technology. In at least one embodiment, the lower interface 12 is a main interface and has at least one widget (not shown). The upper interface 11 is a navigation interface and has at least one widget (see label 111 of FIG. 1). Each widget can be an ActiveX widget, a desktop widget, or other widget. In another embodiment, the upper interface 11 includes a first widget 111.

The electronic device 100 can be operated by touches on the touch panel 20. The touch panel 20 includes a detection unit 21. The detection unit 21 is configured to detect a present touch acting on the touch panel 20 and to generate an operation signal as a consequence of such detection. As different kinds of touch can be detected, the detection unit 21 is configured to generate different kinds of operation signal. In at least one embodiment, when the detection unit 21 detects the present touch to be a first operation, a first operation signal is generated by the detection unit 21. When the detection unit 21 detects that the present touch is a different second operation, a different second operation signal is generated by the detection unit 21. In another embodiment, when the present touch acting on the touch panel 20 is equivalent to a mouseclick, the first operation signal is generated by the detection unit 21. When the present touch acting on the touch panel 20 is equivalent to a dragging or sliding, the second operation signal is generated by the detection unit 21.

When the display unit 10 displays only one interface and the present touch is on the interface directly, the operation signal generated by the detection unit 21 is transmitted to the interface. The processing unit 40 controls the response to the operation signal to the interface.

When the display unit 10 displays both the upper interface 11 and the lower interface 12, the determination unit 30 is configured to determine whether the present touch is applied to the upper interface 11 or to the lower interface 12. When the present touch is on the upper interface 11, the determination unit 30 transmits the operation signal from the upper interface 11 to the lower interface 12. When the present touch acts on the lower interface 12 directly, the operation signal generated by the detection unit 21 is directly transmitted to the lower interface 12.

The processing unit 40 is configured to determine the kinds of the operation signals which may be transmitted to the lower interface 12 and to control the upper interface 11 or the lower interface 12 to respond according to the kinds of the operation signals. In at least one embodiment, when the processing unit 40 determines the operation signal be the first operation signal, the upper interface 11 is controlled to respond by the processing unit 40. When the processing unit 40 determines the operation signal be the second operation signal, the lower interface 12 is controlled to respond by the processing unit 40.

Further, the processing unit 40 is configured to mark the widget of upper interface 11 when the upper interface 11 is acted on by the present touch. In at least one embodiment, when the present touch acts on the first widget 111, the first widget 111 is marked by the processing unit 40. The processing unit 40 is configured to determine whether the operation signal to be the first operation signal and to control the first widget 111 to respond the first operation signal.

In at least one embodiment, when the processing unit 40 determines that the operation signal transmitted to the lower interface 12 is the first operation signal, the processing unit 40 can confirm the present touch is the equivalent of a mouseclick. The marked widget of upper interface 11 (such as the first widget 111) is controlled to respond the click. When the processing unit 40 determines that the operation signal transmitted to the lower interface 12 is the second operation signal, the processing unit 40 can confirm the present touch is the drag or slide. The lower interface 12 is controlled to respond the drag or slide.

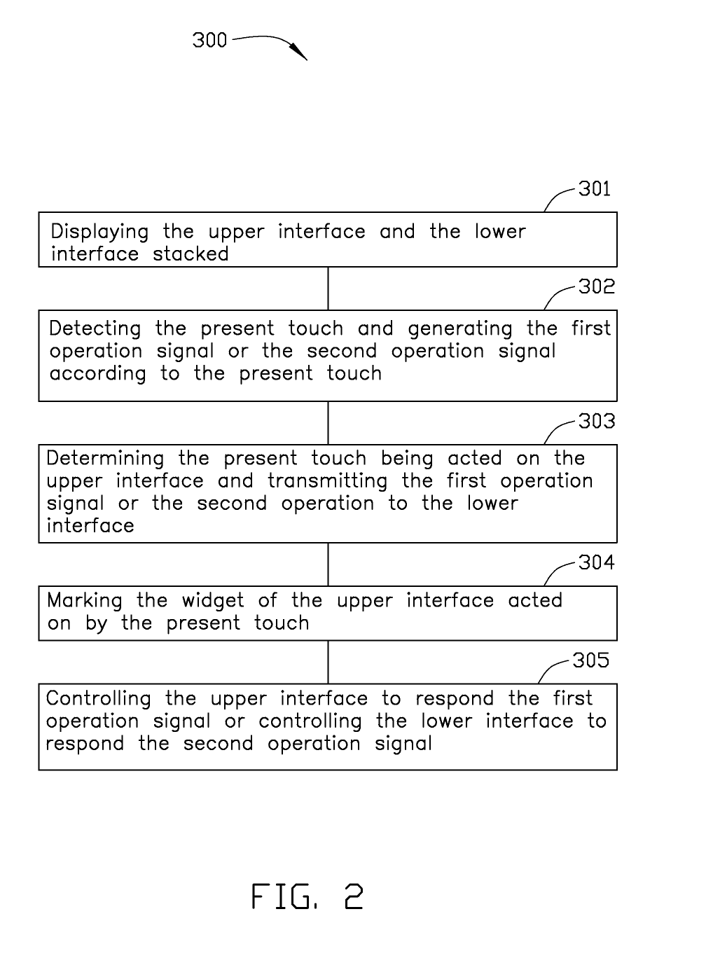

FIG. 2 illustrates a flowchart in accordance with an example embodiment. The method 300 is provided by way of example, as there are a variety of ways to carry out the method. The method 300 described below can be carried out using the configurations illustrated in FIG. 1, for example, and various elements of these figures are referenced in explaining the example method. Each block shown in FIG. 2 represents one or more processes, methods, or subroutines, carried out in the exemplary method 300. Furthermore, the illustrated order of blocks is by example only and the order of the blocks can change. Additional blocks may be added or fewer blocks may be utilized, without departing from this disclosure. The exemplary method 300 can begin at block 301.

At block 301, the display unit 10 displays the upper interface 11 and the lower interface 12 stacked.

At block 302, the detection unit 21 detects the present touch acting on a touch panel 20. When the present touch acting on the touch panel 20 is equivalent to mouseclick, the detection unit 21 generates the first operation signal and when the present touch acting on the touch panel 20 is a drag or slide, the detection unit 21 generates the second operation signal.

At block 303, when the determination unit 30 determines that the present touch is applied to the upper interface 11, the first operation signal or the second operation signal is transmitted to the lower interface 12.

At block 304, when the present touch acts on any widget of the upper interface 11, such as the first widget 111 being touched, the first widget 111 is marked by the processing unit 40.

At block 305, the processing unit 40 determines that the operation signal transmitted to the lower interface 12 is the first operation signal and controls the marked widget of upper interface 11 to respond the first operation signal. If the processing unit 40 determines that the operation signal transmitted to the lower interface 12 is the second operation signal then the lower interface 12 is controlled to respond to the second operation signal.

The sequence of the block 303 and the block 304 can be exchanged or can be invoked simultaneously.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including, the full extent established by the broad general meaning of the terms used in the claims.

What is claimed is:

1. An electronic device comprising:
a touch panel having a detection unit, the detection unit configured to detect a present touch acting on the touch panel and to generate an operation signal as a consequence of such detection;
a display unit configured to display an upper interface and a lower interface stackable relative to the upper interface;
a determination unit configured to judge the present touch applying to the upper interface or the lower interface; wherein when the present touch acts on the upper interface, the determination unit transmits the operation signal from the upper interface to the lower interface; and
a processing unit configured to control the upper interface or the lower interface to respond the operation signal.

2. The electronic device of claim 1, wherein the detection unit is configured to generate a first operation signal or a different second operation signal.

3. The electronic device of claim 2, wherein when the detection unit detects the present touch be a first operation, a first operation signal is generated by the detection unit; and when the detection unit detects the present touch is a different second operation, a different second operation signal is generated by the detection unit.

4. The electronic device of claim 3, wherein when the present touch is click, the first operation signal is generated by the detection unit, and when the present touch is slide, the second operation signal is generated by the detection unit.

5. The electronic device of claim 2, wherein the processing unit is configured to judge the operation signal transmitting to the lower interface be the first operation signal or the second operation signal.

6. The electronic device of claim 5, wherein the processing unit is configured to control the upper interface to respond the first operation signal.

7. The electronic device of claim 5, wherein the processing unit is configured to control the lower interface to respond the second operation signal.

8. The electronic device of claim 1, wherein the upper interface comprises a first widget, and the processing unit is configured to mark the first widget.

9. The electronic device of claim 8, wherein the first widget is controlled to respond the operation signal by the pressing unit.

10. The electronic device of claim 8, wherein when the present touch acts on the first widget, the first widget is marked by the processing unit.

11. A method of stacking interfaces and managing responses comprising:
displaying an upper interface and a lower interface stacked;
detecting a present touch acting on a touch panel and generating an operation signal as a consequence of such detection;
determining the present touch acting on the upper interface and transmitting the operation signal to the lower interface; and
controlling the upper interface or the lower interface to respond the operation signal.

12. The method of stacking interfaces and managing responses of claim 11, further comprising generating a first operation signal when the present touch be the first operation, and generating a different second operation signal when the present touch be the second operation.

13. The method of stacking interfaces and managing responses of claim 12, further comprising determining the operation signal transmitting to the lower interface be the first operation signal or the second operation signal.

14. The method of stacking interfaces and managing responses of claim 13, further comprising controlling the upper interface responding the first operating signal or controlling the lower interface responding the second operating signal.

15. The method of stacking interfaces and managing responses of claim 11, further comprising marking a first widget of the upper interface when the present touch acting on the upper interface.
